(19) United States
(12) Patent Application Publication
(10) Pub. No.: US 2008/0072858 A1
(43) Pub. Date: Mar. 27, 2008

(54) Apparatus for Providing Fuel Saving and Low Emission Heavy Fuel Oil

(76) Inventor: Wei-Ming Chang, Taoyuan City (TW)

Correspondence Address: HDSL, 4331 STEVENS BATTLE LANE, FAIRFAX, VA, 22033, US

(21) Appl. No.: 11/534,405

(22) Filed: Sep. 22, 2006

(51) Int. Cl. F02B 43/00; F02B 1/12

(52) U.S. Cl. 123/1 A; 123/27 R

(57) ABSTRACT

An apparatus for providing fuel saving and low emission heavy fuel oil includes an additive providing unit, a lower emission heavy fuel oil providing unit, a lower emission heavy fuel oil preparation unit, a complementary homogenizer seal cooling unit, a fuel oil supply unit, a main controller, and an emulsifier heavy fuel oil providing unit. With these configurations, the user can directly prepare fuel saving and low emission heavy fuel oil or emulsified heavy fuel oil via operating this apparatus on line.

### BACKGROUND

The present invention relates to the field of heavy fuel oil providing apparatus, and more particularly to an apparatus for providing blended heavy fuel oil, of which, the user can prepare fuel saving heavy fuel oil or emulsified heavy fuel oil via directly operation of the apparatus on line for application.

Heavy fuel oil is a type of fuel which is very viscous and does not flow easily due to high colloidal asphaltene content. The heavy fuel oil should be heated up before use, and heating temperature should be higher when viscosity of heavy fuel oil is increased. During the repeatedly heating process, resin, together with the short-carbon-chain hydrocarbon, the natural-condensate-resistant-substance in the heavy fuel oil will suspend to the upper level of the tank, and the asphaltene is caramelized and liable to form oil sludge, and adhered to the wall of the pipeline, or sinking to the bottom floor of the tank, this will cause serious problem to heavy fuel oil storage and transportation.

Moreover, water contain in the heavy fuel oil is generally at a range of 0.3%-2.0%, the heavy oil is liable to incomplete emulsified without homogenizing process. When heating up heavy fuel oil up to 100° C., the water remaining in the incomplete emulsified heavy fuel oil will change its phase and to be vaporized, under this circumstance, it will absorb a great deal of heat, this is so called “latent-heat-absorbent when vaporization”, and combustion then will be interfered sequentially. In some cases, flame of combustion may be put out. This phenomenon may cause energy lost and environment impact in the end.

Under these circumstances, various solution to overcome the above described have been developed, such as fuel-homogenization, heavy fuel oil emulsified, and dosing additive and so on. These solutions are based on the same theory—minimizing fuel droplet diameter in order to obtain oxygen efficiently, which are intended to make droplets of the heavy oil as much as possible in order to increase combustion efficiency accordingly.

However, these solutions are liable to induce following shortcomings:

Firstly, the atomization of the heavy fuel oil that combusted in the internal combustion engine or fuel oil burner are determined by performance of the fuel injection nozzle, that is, after spurting into the burner via the nozzle, the homogenized heavy fuel oil will be still suffered.

Secondly, emulsified heavy fuel oil is a mixture which is formed by dosing water and surfactants into the heavy fuel oil in a certain ratio and then homogenized in sequential. Nowadays, all the emulsified heavy fuel oil are massively produced in advance, and shipped to the users afterwards, the emulsified heavy oil are liable to a incomplete emulsified during a duration of long time storage, which will impact the stability thereof. Especially, when it comes to heating, water remaining in the heavy fuel oil will break through and come out from the oil easily.

Thirdly, the components of the additive may be inclusive of asphaltene dispersant, catalyst, combustion improvement, and viscosity decrease and the like, these additives may help to improve the utilization efficiency of the heavy fuel oil, and to eliminate emission problem. But it may just acquire an intermittent effect if a homogenization for the mixture, i.e., heavy fuel oil with additive, can not be taken place sequentially.

Accordingly, what is needed is an apparatus for providing fuel saving and low emission heavy fuel oil that can overcome the above-described deficiencies.

### BRIEF SUMMARY

An exemplary apparatus for providing fuel saving and low emission heavy fuel oil includes an additive preparation unit, an fuel saving and low emission heavy fuel oil providing unit, a complementary homogenizer seal cooling unit, a fuel oil supply unit, a main controller, and an emulsifier heavy fuel oil providing unit.

With these configurations, the user can directly provide fuel saving and low emission heavy fuel oil or emulsified heavy fuel oil via operating this apparatus on line.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a systematic diagram illustrating an apparatus for providing blended heavy fuel oil, and to produce fuel saving and low emission heavy fuel oil.

### DETAILED DESCRIPTION

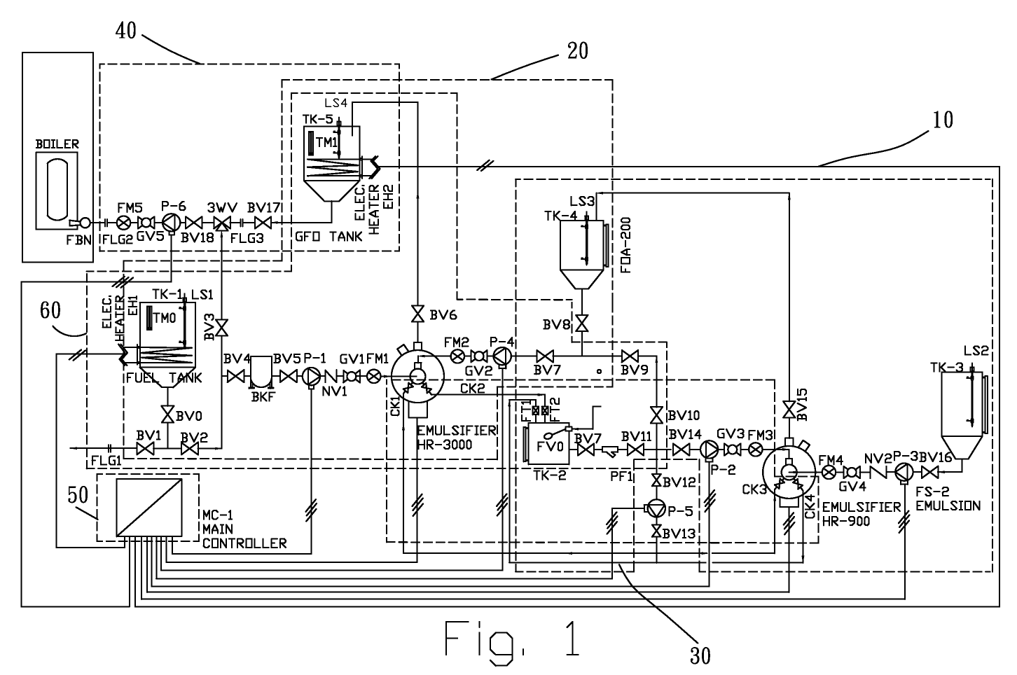

Referring to FIG. 1, an apparatus for providing heavy fuel oil is shown. The user can use this apparatus on line to provide fuel saving and low emission heavy fuel oil.

The apparatus for blending heavy fuel oil mainly includes an additive providing unit 10, a fuel saving and low emission heavy fuel oil preparation unit 20, an homogenizer(s) seal cooling unit 30, a fuel oil supply unit 40, a main controller 50, and an emulsified heavy fuel oil providing unit 60.

The additive providing unit 10 includes a tank TK-3 having a liquid level sensor LS2 for containing emulsion FS-2, a water tank TK-2 having a floating ball valve FV0 and two pipe filters FT1 and FT2, an emulsion transport pump P-3, a tank TK-4 having a liquid level sensor LS3 for containing additive, a homogenizer HR-900, a water transport pump P-2, five ball valves BV19, BV11, BV14, BV15 and BV16, a check valve NV2, two gate valves GV3 and GV4, two flow meters FM3 and FM4, a pipe filter PF1, and a plurality of pipes for connecting above-described elements thereof.

The fuel saving and low emission heavy fuel oil providing unit 20 includes a tank TK-1 with an electric heater EH1, a liquid level sensor LS1, and a temperature sensor TM) for containing heavy fuel oil, the tank TK-4 having the liquid level sensor LS3 (jointly use with the additive preparation unit 10), a heavy fuel oil transport pump P-1, an additive FDA-200 transport pump P-4, a homogenizer HR-3000, a tank TK-5 with an electric heater EH2, a liquid level sensor LS4, and a temperature sensor TM1 for containing heavy fuel oil with lower pollution, seven ball valves BV0, BV2, BV4, BV5, BV6, BV7, BV8, and two gate valves GV1 and GV2, a check valve NV1, two flow meters FM1 and FM2, a basket type filter BKF, and a plurality of pipes for connecting above-described elements thereof.

The homogenizer seal cooling unit 30 is mate with the additive providing unit 10, and is used for cooling the homogenizers HR-900 and HR-3000. The seal cooling unit 30 includes the tank TK-2 having the floating ball valve FV0 (jointly use with the additive providing unit 10), a cooling water transport pump P-5, four ball valves BV19, BV11, BV12, BV13, four check valves CK-1˜CK-4, a Y-type filter PF-1, two pipe filter FT1 and FT2, and a plurality of pipes for connecting above-described elements thereof.

The fuel oil supply unit 40 includes the tank TK-5 with an electric heater EH2, the liquid level sensor LS4, and the temperature sensor TM1 for containing heavy fuel oil with lower emission (jointly use with the heavy fuel oil preparation unit 20), a fuel oil transport pump P-6, two ball valves BV17 and BV18, a three way valve 3 WV, a gate valve GV5, a flow meter FM5, two flanges FLG2 and FLG3 for connecting external pipes, and a plurality of pipes for connecting above-described elements thereof.

The emulsified heavy fuel oil providing unit 60 jointly use with part of the element of the heavy fuel oil providing unit 20, which is a selectable process, and the user can operate this providing unit 60 to prepare emulsified heavy fuel oil. The emulsified heavy fuel oil providing unit 60 includes the tank TK1 having an electric heater EH1, a liquid level sensor LS1, and a temperature sensor TM0 jointly use with the heavy fuel oil providing unit 20), the heavy fuel oil transport pump P-1 jointly use with the heavy fuel oil providing unit 20), the water tank TK-2 having the floating ball valve FV0 and two pipe filters FT1 and FT2 jointly use with the additive providing unit 10), the homogenizer HR-3000 jointly use with the heavy fuel oil providing unit 20), the tank TK-5 with the electric heater EH2, the liquid level sensor LS4, and the temperature sensor TM1 for containing heavy fuel oil with lower emission jointly use with the heavy fuel oil providing unit 20). The emulsified heavy fuel oil providing unit 60 further includes ten ball valves BV0, BV2, BV4, BV5, BV6, BV7, BV9, BV10, BV11, BV19, two gate valves GV1 and GV2, two flow meters FM1 and FM2, the basket type filter BKF, the Y-type filter PF1, the check valve NV1 and a plurality of pipes for connecting above-described elements thereof.

The user can prepare heavy fuel oil or emulsified heavy fuel oil having certain component via operating this apparatus on line, and to produce fuel saving and low emission heavy fuel oil.

The additive providing unit 10 is used for preparing the additive FDA-200. The process for fabricating the additive FDA-200 includes the steps of: mixing the multi heavy oil emulsion FS-2 and water in the ratio of 1˜3% to 99˜97%, and the emulsion FS-2 is consisted of surfactants, stabilizers, catalyst, and combustion improvement; homogenizing the mixture in the homogenization HR-900 to form the additive FDA-200.

Moreover, the heavy fuel oil providing unit 20 is used for preparing the fuel saving and low emission heavy fuel oil for fuel burner or internal combustion engine, which includes the steps of: mixing the additive FDA-200 and heavy fuel oil in the ration of 20%˜30% to 80%˜70%; homogenizing the mixture in the homogenization HT-3000 to form the lower emission heavy fuel oil.

The apparatus of the present invention provide two selectable routes. First, the user may use fuel saving and low emission heavy fuel oil after preparation, or choosing to use crude heavy fuel oil without any advanced preparation. Second, the user may change configuration of the pipeline from not to provide with additive FDA-200, and choosing to prepare emulsified heavy fuel oil with crude heavy fuel oil and water so as to directly use emulsified heavy fuel oil on line.

Referring to FIG. 1 again, the process of operating the apparatus to provide fuel saving and low emission heavy fuel oil is controllable by the main controller 50, and will be detail described as below:

The process of preparing the additive includes the steps of: a) injecting multi heavy fuel oil emulsion FS-2 into the tank TK-3, injecting water into the TK-2, and injecting heavy fuel oil into the tank TK-1; there is another way to acquire crude heavy fuel oil, that is, close the ball valve BV0 and open the ball valves BV1 and BV2 to guide heated heavy fuel oil from external oil tank to inner pipes; b) opening the ball valves BV19, BV11, BV14, BV12, BV13 and gate valve GV3 to transport water; c) opening the cooling water transport pump 5 to transport the cooling water into the seal cooling cabin via the seal cooling pipes 14 and the check valve CK3, to cool the seal thereof, then the water will flow back to the tank TK-2 via the cock valve CK4 and the filter FT1; at the same time, the cooling water is also transported into the seal cooling cabin via the seal cooling pipes 13 and the cock valve CK1, to cool the seal thereof, then the water will flow back to the TK-2 via the cock valve CK2 and the filter FT2; d) opening the electric heater EH1 to heat up the heavy fuel oil in the tank TK1 until the viscosity of the heavy fuel oil is lower than 70 cSt and being able to be transported by the pump, and the temperature to be heated is determined by the characteristics of the heavy fuel oil, for example, for heavy fuel oil MF-30 in application of low sulfur content boiler or shipping should be heated up to about 50° C., viscosity then should be lower than 50 cSt; for the heavy fuel oil MF380 in application of shipping heated up to about 80° C., the viscosity could be lower than 60 cSt; as to the heavy fuel oil for the power plant, viscosity could be lower than 70 cSt when it is heated up to 90° C., Nevertheless, heating process may not be necessary when fuel oil is heated and guided from external oil tank; e) opening the ball valve BV16 and the gate valve GV-4 to transport the heavy fuel oil emulsion FS-2; f) opening the ball valve BV15 to transport the additive FDA-200; g) synchronously opening the emulsion transport pump P-3, the water transport pump P-2, and the homogenizer HR-900 to make the heavy fuel oil emulsion FS-2, in this case, mixing ratio of heavy fuel oil emulsion FS-2 and water should be in a ratio of 1˜3% to 99˜97%, then a homogenization of the mixture will be taken place by means of homogenizer HR-900 to form the additive FDA-200, and then to be transported to the tank TK-4 via the pipes 20.

The process of providing the fuel saving and low emission heavy fuel oil includes the steps of: a) opening the ball valves BV0 (or ball valve BV1), BV2, BV4, BV5, BV6, BV7, BV8 and gate valves GV1 and GV2; b) opening the heavy fuel oil transport pump P-1, the homogenizer HR-3000, and the additive FDA-200 transport pump P-4 to make the heavy fuel oil and the additive FDA-200 to mix in the ration of 70%˜80% to 30%˜20% in the homogenizer HR-3000, then homogenizing the mixture therein to form the fuel saving and low emission heavy fuel oil, and then to the tank TK-5 via the pipe #19 sequentially; when the fuel saving and low emission heavy fuel oil touch the liquid lever sensor LS4, the electric heater EH2 will then begin in active continuously and will maintain its temperature up to 90˜100° C., and the fuel will be ready to be used for the fuel oil burner or internal combustion engine later on.

The process of supplying heavy fuel oil includes the steps of: a) opening the ball valves BV17 and BV18, and the gate valve GV5; b) turning the three way valve 3 Wv to make the access of pipe 21 and 22 to connect with each other, and the pipe 21 is interrupted with the pipe 02; c) opening the fuel oil transport pump P-6 to transport the fuel saving and low emission heavy fuel oil into the fuel oil burner FBN or internal combustion engine, and the combustion apparatus begins to use the fuel saving and low emission heavy fuel oil.

The process of providing the emulsified heavy fuel oil includes the steps of (selectable process): a) closing the ball valve BV8, and opening the ball valves BV7, BV9, BV10, BV11, BV19; b) opening the ball valves BV0 (or ball valve BV1), BV2, BV4, BV5, BV6 and gate valves GV1 and GV2; c) synchronously opening the water transport pump P-4 and the heavy fuel oil transport pump P-1 to make the heavy fuel oil and water to mix in a ration of 70%˜80% to 30%˜20% in the homogenizer HR-3000, then homogenizing the mixture therein to form the emulsified heavy fuel oil, and this emulsified heavy fuel oil then to be conducted to the tank TK-5.

The process of using the emulsified heavy fuel oil includes the steps of (selectable process): a) opening the ball valves BV17 and BV18, and gate valve GV5; b) turning the three way valve 3 WV to make the access of pipeline 21 and 22 to connect with each other, and the pipeline 21 is interrupted with the pipe 02; c) opening the fuel oil transport pump P-6 to transport the emulsified heavy fuel oil into the fuel oil burner FBN or internal combustion engine, and the combustion apparatus begins to use the emulsified heavy fuel oil.

The process of using the crude heavy fuel oil without any advanced preparation includes the steps of (selectable process): a) turning the three way valve 3 WV to make the access of pipeline 22 and 02 to connect with each other, and the pipeline 02 is interrupted with the pipeline 21; b) opening the ball valves BVO (or ball valve BV1), BV2, BV3, BV4, BV5; c) closing ball valve BV4; d) opening the fuel oil transport pump P-6 to transport the heavy fuel oil into the fuel oil burner or internal combustion engine.

The apparatus for supplying fuel saving and low emission heavy fuel oil of the present invention covers several advantages on contrast to the other conventional apparatus. Firstly, the fuel saving and low emission heavy fuel oil contains the additive FDA-200, which is not liable to produce emulsion breaking effect due to the stabilizers contained in the additive FDA-200. During the process of combustion, dropping of gross calorific value of the fuel saving and low emission heavy fuel oil is about 5%˜6%, which is much less than that of any other type of emulsified heavy fuel oil, and also within the range of tolerance of the gross calorific value on contrast to the crude heavy fuel oil. Moreover, this fuel saving and low emission heavy fuel oil is consisted of water in a ration of 20%˜30%, and multi-function heavy fuel oil emulsion FS-2 in a ration of 0.3%˜0.6%. Therefore, this fuel saving and low emission heavy fuel oil prepared by this apparatus may generate more calorific value relatively.

Secondly, the process of the heavy fuel oil additive providing unit 10 and the heavy fuel oil providing unit 20 may be directly operation on line respectively, thus the user need not to arrange a big tank for keeping the additive FDA-200 nor the fuel saving and low emission heavy fuel oil on the question. The user can adjust the units on line according to the combustion in the fuel burner or internal combustion engine until when combustion is optimized.

Thirdly, preparing the fuel saving and low emission heavy fuel oil by this apparatus of the present invention could save the gross of the oil reversed and could eliminate emission such as CO₂, NOₓ, SOₓ, Soot, and suspended solids to be exhausted.

Fourthly, the fuel saving and low emission heavy fuel oil is produced by two-step-continuous homogenization processes, stability and homogenization thereof should be higher than that the other blended heavy fuel oil with one step process.

Fifthly, the apparatus of the present invention provides selectable routes to be chosen by the user, the user can conveniently select to prepare fuel saving and low emission heavy fuel oil, emulsified heavy fuel oil, or to chose using unblended crude heavy fuel oil directly.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Furthermore, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An apparatus for providing fuel saving and low emission heavy fuel oil, comprising:
an additive providing unit, comprising a tank (TK-3) for containing multi-function heavy fuel oil emulsion, a tank (TK-4) for containing heavy fuel oil additive, an emulsion transport pump (P-3), a water transport pump (P-2), a homogenizer (HR-900), a water tank (TK-2), and a plurality of pipeline for connecting the elements thereof,
an lower emission heavy fuel oil providing unit, comprising a tank (TK-1) for containing heavy fuel oil, a homogenizer (HR-3000), a tank (TK-5) for containing environment friendly heavy fuel oil, an additive transport pump (P-4), a heavy fuel oil transport pump (P-1), the tank (TK-4) that jointly use with the additive preparation unit, and a plurality of pipeline for connecting the elements thereof,
a homogenizer seal cooling unit, which is being mate with the additive preparation unit, and is being used for cooling the homogenizers, the seal cooling unit includes the tank (TK-2) that jointly use with the additive preparation unit, a cooling water transport pump (P-5), check valves, filters, and a plurality of pipeline for connecting the elements thereof,
a fuel oil supply unit, comprising the tank (TK-5) that jointly use with the heavy fuel oil providing unit, a fuel oil transport pump (P-6), control valves, flow meters , and a plurality of pipelines for connecting the elements thereof,
Wherein, the user can provide the fuel saving and low emission heavy fuel oil or emulsified heavy fuel oil via operating the apparatus on line.

2. The apparatus for providing fuel saving and low emission heavy fuel oil as claimed in claim 1, wherein in the additive preparation unit, the tank (TK-3) comprises a liquid level sensor (LS2), the water transport tank (TK-2) comprises a floating ball valve (FV0) and two pipeline filters (FT1 and FT2), the tank (TK-4) comprises a liquid level sensor (LS3); a ball valve (BV16), a check valve (NV2), a gate valve (GV4), and a flow meter (FM4) are disposed in pipes that between the tank (TK-3) and the homogenizer (HR-900); a ball valve (BV15) is disposed in pipeline that between the tank (TK-4) and the homogenizer (HR-900); three ball valves (BV19, BV11, BV14), a filter (PF1), a gate valve (GV3), and a flow meter (FM3) are disposed in pipes that between the tank (TK-2) and the homogenizer (HR-900).

3. The apparatus for providing fuel saving and low emission heavy fuel oil as claimed in claim 1, wherein in the lower emission heavy fuel oil preparation unit, the tank (TK-1) comprises an electric heater (EH1), a liquid level sensor (LS1), and a temperature sensor (TM0), the tank (TK-4) comprises a liquid level sensor (LS3), the tank (TK-5) comprises an electric heater (EH2), a liquid level sensor (LS4), and a temperature sensor (TM1); four ball valves (BV0, BV2, BV4, BV5), a basket type filter (BKF), a gate valve (GV1), a check valve (NV1), and a flow meter (FM1) are disposed in the pipes that between the tank (TK-1) and the homogenizer (HR-3000); two ball valves (BV8 and BV7), a gate valve (GV2), and a flow meter (FM2) are disposed in the pipes that between the tank (TK-4) and the homogenizer (HR-3000); a ball valve (BV6) is disposed in the pipes that between the tank (TK-5) and the homogenizer (HR-3000).

4. The apparatus for providing fuel saving and low emission heavy fuel oil as claimed in claim 1, wherein in the homogenizer seal cooling unit, the tank (TK-2) comprises a floating ball valve (FV0); four ball valves (BV19, BV11, BV12, BV13), a Y-type filter (PF-1), four check valves (CK-1˜CK-4), and two pipe filters (FT1 and FT2) are disposed in the pipes that between the tank (TK-2) and the two homogenizers (HR-900 and HR-3000).

5. The apparatus for providing fuel saving and low emission heavy fuel oil as claimed in claim 1, wherein in the fuel oil providing unit, the tank (TK-5) comprises an electric heater (EH2), a liquid level sensor (LS4), and a temperature sensor (TM1); two ball valves (BV17 and BV18), a three way valve (3 WV), a gate valve (GV5), a flow meter (FM5), two flanges (FLG2 and FLG3) for connecting external pipelines are disposed in the pipes that between the tank (TK-5) and burning system.

6. The apparatus for providing fuel saving and low emission heavy fuel oil as claimed in claim 1, further comprising an emulsified heavy fuel oil providing unit that jointly use part of the elements of the heavy fuel oil preparation unit.

7. The apparatus for providing fuel saving and low emission heavy fuel oil as claimed in claim 6, wherein the emulsified heavy fuel oil preparation unit comprises the tank (TK-1) having an electric heater (EH1), a liquid level sensor (LS1), and a temperature sensor (TM0); the water tank (TK-2) having the floating ball valve (FV0) and two pipe filters (FT1 and FT2); the heavy fuel oil transport pump (P-1); the homogenizer HR-3000; the tank (TK-5) having an electric heater (EH2), a liquid level sensor (LS4), and a temperature sensor (TM1); five ball valves (BV19, BV11, BV10, BV9, BV7), a gate valve (GV2), a flow meter (FM2), a Y-type filter (PF-1) are disposed in the pipes that between the tank (TK-2) and the two homogenizers (HR-3000); four ball valves (BV0, BV2, BV4, BV5), a basket type filter (BKF), a gate valve (GV1), a flow meter (FM1), and a not return valve (NV1) are disposed in the pipes that between the tank (TK-1) and the homogenizer (HR-3000); a ball valve (BV16) is disposed in the pipes that between the tank (TK-5) and the homogenizer (HR-3000).
